(19) United States
(12) Patent Application Publication
(10) Pub. No.: US 2017/0064911 A1
(43) Pub. Date: Mar. 9, 2017

(54) WATER RECAPTURE SYSTEM

(71) Applicant: John Trujillo, El Cajon, CA (US)

(72) Inventor: John Trujillo, El Cajon, CA (US)

(21) Appl. No.: 15/260,228

(22) Filed: Sep. 8, 2016

Related U.S. Application Data
(60) Provisional application No. 62/215,883, filed on Sep. 9, 2015.

(51) Int. Cl. A01G 9/04; A01G 25/09; A01G 25/02; B05B 15/06; B05B 9/04; B05B 9/00; B05B 12/00; A01G 25/14; B05B 7/24

(52) U.S. Cl. CPC A01G 9/045; A01G 25/145; A01G 25/09; A01G 25/023; B05B 7/2486; B05B 9/0423; B05B 9/007; B05B 12/002; B05B 15/061

(57) ABSTRACT

In an embodiment, a water recapture system comprises one or more trays having a bottom surface and one or more sidewalls extending upward from the bottom surface, wherein the bottom surface has at least one aperture extending therethrough. A platform configured to engage a top side of the one or more sidewalls, wherein the platform has a first tab and a second tab, wherein the first tab and the second tab extend outwardly from the platform. A coupler extending through the at least one aperture of the bottom surface, wherein one end of the coupler is exterior to the tray, and wherein a hose attached to the one end of the coupler, wherein the bottom surface of the tray is contoured, and wherein the contour of the bottom surface is biased towards the at least one aperture.

### CROSS-REFERENCE TO RELATED APPLICATION(S)

The present application claims priority to U.S. Provisional Patent Application No. 62/215,883 filed on Sep. 9, 2015, entitled “Water Recapture Tray System” the entire disclosure of which is incorporated by reference herein.

### BACKGROUND OF THE INVENTION

1. Field of Invention

This invention relates generally to devices used for excess water recapture and conservation from watering plants, for example. More specifically, this relates to multipurpose tray systems for the storage or display of plants or other horticultural applications.

2. Description of Related Art

Water is a non-renewable resource that plays a vital role in the survival of humans and plants. Current conservation efforts have not been able to provide for a universal solution to water shortages and the need to use water both commercially and individually remains. One of the most wanton and unnecessary wastes for water comes from the watering process of plants. Commercial plant retailers rely on water to be able to hydrate their inventory. It is ineffective both financially and regarding time to carefully and precisely water each individual plant to ensure no water is wasted through runoff or over saturation dripping. Generally, in both commercial and individual settings, plants are watered in bulk through a blanket style watering process that is indiscriminate and wasteful. The pots holding the plants have gaps and a large amount of water is wasted by simply missing the pot and allowing the water to fall to the ground where it is absorbed or evaporated. There is no reason that this excess wasted water could not be recollected and reapplied.

Prior art consists of drip trays or other vessels without holes for holding plant pots, thereby collecting excess water when the pots are watered. The stagnant water is then intended to be taken up the root systems or will simply evaporate. Even with these types of trays, the water is still able to overflow and will typically be allowed to fall onto a floor or surface and the water will be wasted. Small plants, bushes and trees manufactured and sold for home gardening are generally grown in open pot systems, from which dripping water is collected in typically flat trays. Such trays are designed only to keep the excess water from flooding the surrounding areas. Once a tray is full, the plant-bearing pots must be lifted and repositioned so that the tray can be transported to a nearby receptacle for draining. This process is laborious and wasteful. Commercially, large plant distributors and retailers fail to utilize any type of a tray for the recollection or recirculation of excess water.

There is an immediate need for a solution for body commercial and residential applications of water recollection for horticultural applications. Water is a vital and limited resource and allowing excess or runoff water to simply evaporate is inefficient and costly. A closed system that will allow for easy and inexpensive installation as well as operation is needed for water conservation. Excess and runoff water can be conserved through the application of a closed tray system that collects, transports and filters the excess water from plants.

### SUMMARY OF THE INVENTION

In an embodiment, a water recapture system comprises one or more trays having a bottom surface and one or more sidewalls extending upward from the bottom surface, wherein the bottom surface has at least one aperture extending therethrough. A platform configured to engage a top side of the one or more sidewalls, wherein the platform has a first tab and a second tab, wherein the first tab and the second tab extend outwardly from the platform. A coupler extending through the at least one aperture of the bottom surface, wherein one end of the coupler is exterior to the tray, and wherein a hose attached to the one end of the coupler, wherein the bottom surface of the tray is contoured, and wherein the contour of the bottom surface is biased towards the at least one aperture.

In an embodiment, the trays are interlocking, wherein one or more of the sidewalls comprise a plurality of clips, and wherein the clips connect separate trays together.

In an embodiment, the water recapture system further comprises one or more filters, wherein the one or more trays comprise an opening through an upper edge of at least one of the sidewalls, wherein the one or more filters are axially aligned with the bottom surface of the tray.

In an embodiment, the contour of the bottom surface facilitates excess water flow throughout the bottom surface of the tray to the at least one aperture, wherein the contour of the bottom surface is selected from the group consisting of: curved, channeled, corrugated, and tapered.

In an embodiment, the water recapture system further comprises at least one tank having a plurality of openings, wherein each hose of the one or more trays is in communication with at least one opening of the tank, wherein the tank receives excess water.

In an embodiment, the water recapture system further comprises a power source and at least one pump electrically connected to the power source, wherein the pump pumps water held inside the tank to a re-watering system

In an embodiment, the re-watering system further comprises at least one hose having a first end attached to the pump and a second end attached to a watering device, wherein the watering device directs the flow of water from the pump.

In an alternative embodiment, a water recapture system comprises one or more trays having a bottom surface and one or more sidewalls extending upward from the bottom surface, wherein the bottom surface has at least one aperture extending therethrough. A platform configured to engage a top side of the one or more sidewalls. A coupler extending through the at least one aperture of the bottom surface, wherein one end of the coupler is exterior to the tray, and wherein a hose attached to the one end of the coupler. A re-watering system having at least one tank in communication with the one or more trays. One or more re-watering devices in communication with the tank, wherein the bottom surface of the tray is contoured, wherein the contour of the bottom surface is biased towards the at least one aperture, wherein the tank receives excess water, wherein the one or more re-watering devices directs the flow of the excess water.

In an embodiment, at least one of the one or more re-watering devices comprises a base; a pole extending upwardly from the base; and a watering module in communication with the pole.

In an embodiment, the base further comprises at least one attachment mechanism to receive a hose extending from the tank to the at least one re-watering device, wherein the attachment mechanism is in communication with the watering module.

In an embodiment, the water recapture system further comprises an articulating armature attached to the pole, wherein the armature extends and retracts generally perpendicular from the pole, and wherein the watering module is attached to an opposite end of the armature from the pole.

In an embodiment, the pole comprises a plurality of pole sections, wherein each pole section is telescopically engaged with an adjacent pole section.

In an embodiment, the water module comprises a handle having a trigger mechanism, wherein the trigger mechanism is mechanically connected to at least one actuator, wherein the at least one actuator controls one or more valves, a tube extending from the handle; and at least one sprinkler head attached to the tube, wherein the sprinkler head directs the flow of water from the re-watering device.

In another embodiment, the handle is removeably engaged to the water module. In use, the handle may be removed and substituted with another watering mechanism. For example, the handle may be removed and the watering module will direct an open flow of water; or a different style of sprayer is attached allowing for diverse and variable spray patterns.

In an embodiment, one or more sprinkler heads are rotationally mounted to the tube, wherein the sprinkler heads are fully adjustable and rotational.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a plan view of the water recapture tray system, according to an embodiment of the present invention;

FIG. 2 is an explosion view of the water recapture tray system, according to an embodiment of the present invention.

FIG. 3 is a plan view of the water recapture tray system, according to an embodiment of the present invention.

FIG. 4 is a plan view of the water recapture tray system, according to an embodiment of the present invention.

FIG. 5 is a plan view of the water recapture tray system, according to an embodiment of the present invention.

FIG. 6 is a plan view of the water recapture tray system, according to an embodiment of the present invention.

FIG. 7 is a perspective view of the watering module according to an embodiment of the present invention.

FIG. 8 is a perspective view of the watering device according to an embodiment of the present invention.

### DETAILED DESCRIPTION OF PREFERRED EMBODIMENTS

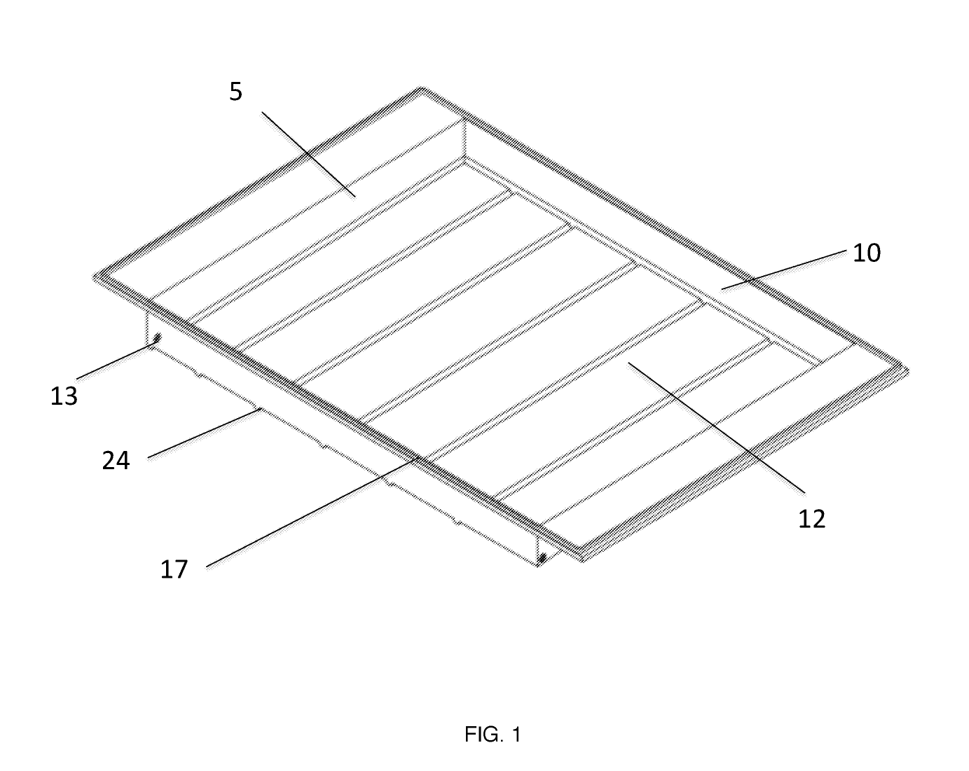

Preferred embodiments of the present invention and their advantages may be understood by referring to FIGS. 1-8 wherein like reference numerals refer to like elements.

FIG. 1 is a schematic diagram of presently preferred embodiments for a water recapture drip tray system 1. The system 1 includes at least one tray 5 working in conjunction with each other. Each tray 5 has a bottom surface 12 that has at least one hole 13 to allow fluids to flow through. The bottom surface 12 continuously extends across the entire bottom of the tray 5 between all found sides. Each tray 5 includes sidewalls 10 extending upwardly from a bottom surface 12 connected to the sidewalls 10. The sidewalls 10 may be continuous material such that they prevent any water from passing through. Each sidewall 10 extends along the length and width of the tray 5 until they encounter another sidewall 10 to form a corner. The system further includes a platform 20 that is held in place by the sidewalls 10 and provides for a level surface that acts as a support to place objects on. The platform 20 is a perforated and rigid material intended to have sufficient strength to be able to support the weight of an object placed on it. The platform 20 may have a grid pattern similar to a honeycomb structure or grate. The platform 20 may have integrated structural supports such as a plurality of integrated joists extending from one side to the other such that they bolster the supportive capabilities. The platform 20 may also have sides that are configured to an angle such that they allow for the platform to rest on top of the side walls 10, thereby holding it in place.

In one embodiment of the present invention, the bottom surface 12 is horizontal and contains one or more holes 13 configured to permit excess water to flow through the bottom. The bottom surface 12 may have attributes that allow for optimal water collection such as a slope, curvature, corrugation, or at least one channel. A bottom surface 12 has a corrugated or ribbed surface. The ribs and corrugation will assist in directing the water that has accumulated on the bottom surface towards the holes.

In another embodiment of the present invention, the bottom surface 12 is sloped. The slope would assist in the flow and accumulation of the water on the bottom surface 12. A slope would allow for consolidation of the water on the bottom surface 12 to the lowest area of the slope. At least one hole 13 may be incorporated into the bottom surface 12 at the lowest point of the slope to maximize water recapture.

In another embodiment of the present invention, the bottom surface 12 is curved in a shape similar to a bowl. At least one hole 13 may be at the minimal point of the curvature as this is the point where the water would be directed to through gravitational forces.

The sidewalls 10 extend upwardly from the bottom surface 12 regardless of the shape or attribute of the bottom surface 12. The side walls 10 support the platform 20 either by a channel in one or more of the side walls 10 allowing the platform 20 to engage the side walls 10; a ridge 17 on the interior surface of the side walls 10 to allow the platform 20 to be placed on; a snap or pressure mechanism to hold the platform 20 in place between the sidewalls 10; or an external mechanism to affix the platform 20 to the side walls 10.

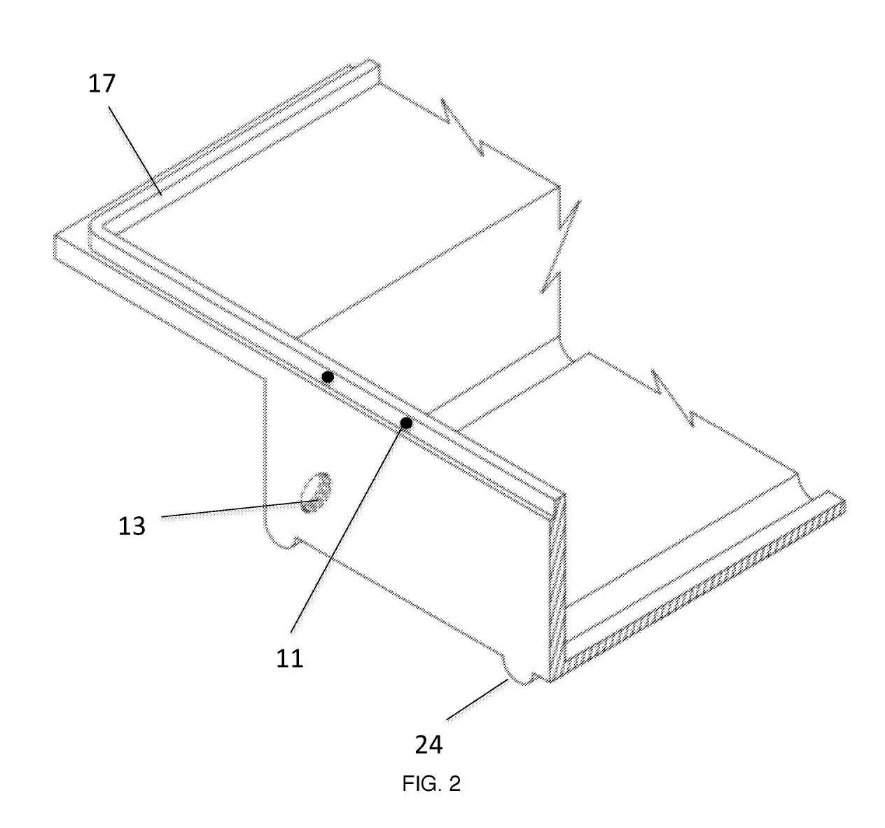

In reference to FIG. 2, a corner section of the tray 5 is shown for detail of an embodiment of the present invention. One or more ridges 17 allows for additional support of a grate or other object resting on top of the tray 5. A plurality of clamping holes 11 are molded to the perimeter of the tray allowing for clamps to hold the tray 5 in place. In an embodiment, the clamps are connected to supporting structures that may be necessary depending on the weight of the contents resting on the tray as well as large amounts of water there within.

In an embodiment, a ridge 17 may be molded to the sidewall 10 to prevent overflow of the fluid in the tray 5. The ridge 17 also additionally functions as extra support features.

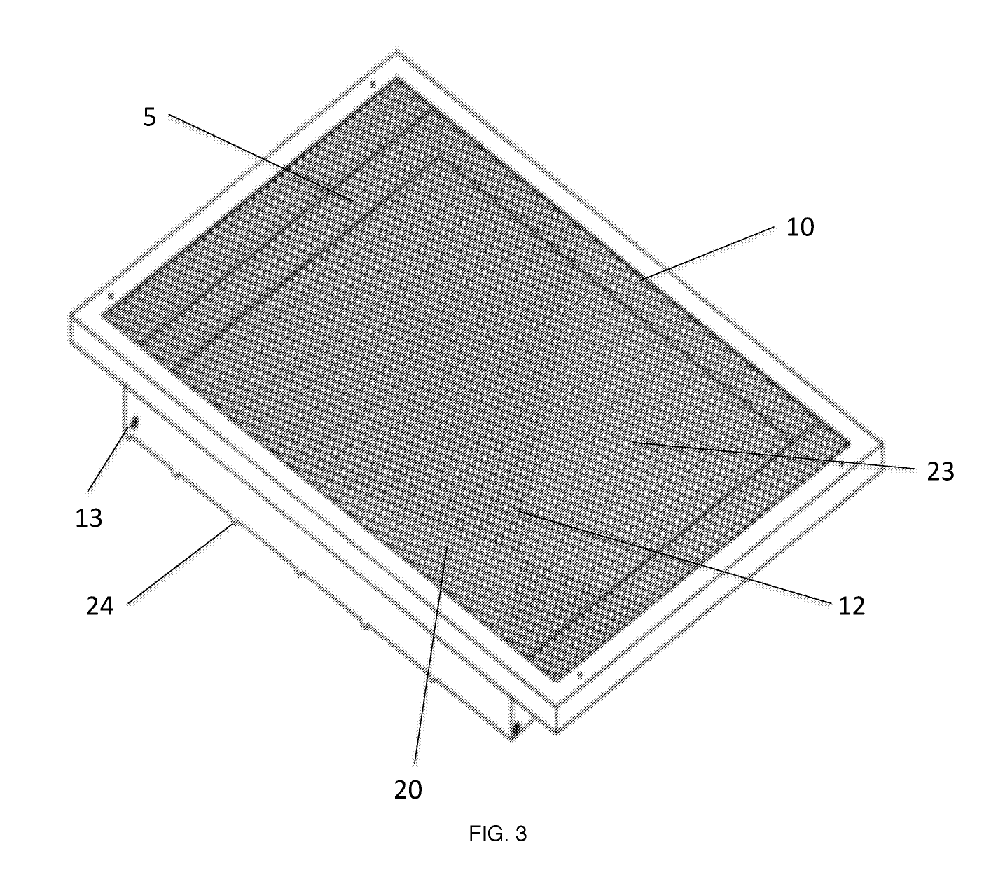

FIG. 3 illustrates another embodiment of the present invention. The platform 20 is perforated. Perforations in the platform 20 material may range in size depending on the application. In any size, the perforations 24 would be at least large enough to allow water to pass through.

In another embodiment of the present invention, the platform 20 is grated. The grate pattern may vary depending on the application. Types of grate patterns may include a plethora of different geometric shapes configured to allow for the passage of water through the grate openings while maintaining sufficient rigidity to support an object, such as a plant, on the platform 20 surface. Regardless of the grate pattern, the grate openings 23 would be sufficiently large to allow for objects to be retained thereon while simultaneously allowing for fluids to fall through the platform onto the bottom surface 12 and then out of the tray 5 through the hole 13 in the bottom surface 12.

In another embodiment of the present invention, a filter element is included to prevent debris from preventing the flow of water through the hole 13 in the bottom surface. The filter may be selectively permeable to prevent undesired material to pass through. The tray 5 may have a space between the platform 20 and the bottom surface and a filter would be placed in between the platform 20 and the bottom surface. The sidewalls 10 may have a channel to accept the filter or the filter may simply sit on the bottom surface 12. The filter would prevent any debris from passing through from the platform to the bottom surface 12. The debris would be held in the filter until it was removed and replaced or cleaned. The filter would be permeable to fluids. In an embodiment, the filter is composed of a material that is waterproof with anti-bacterial or aseptic properties. A synthetic plastic like material would be sufficient.

In another embodiment, the filter is a multilayer filter. For example, the multilayers are porous material to initiate filtration of liquids passing therethrough, or a layer containing additives to be added to the liquids passing through the filter such that the liquid leaving the filter has received one or more of the additives from the additive filter layer. Other layers may include ionized material or chemically reactive material for removing undesirable materials from the liquid passing through the filter from entering the water recapture tank.

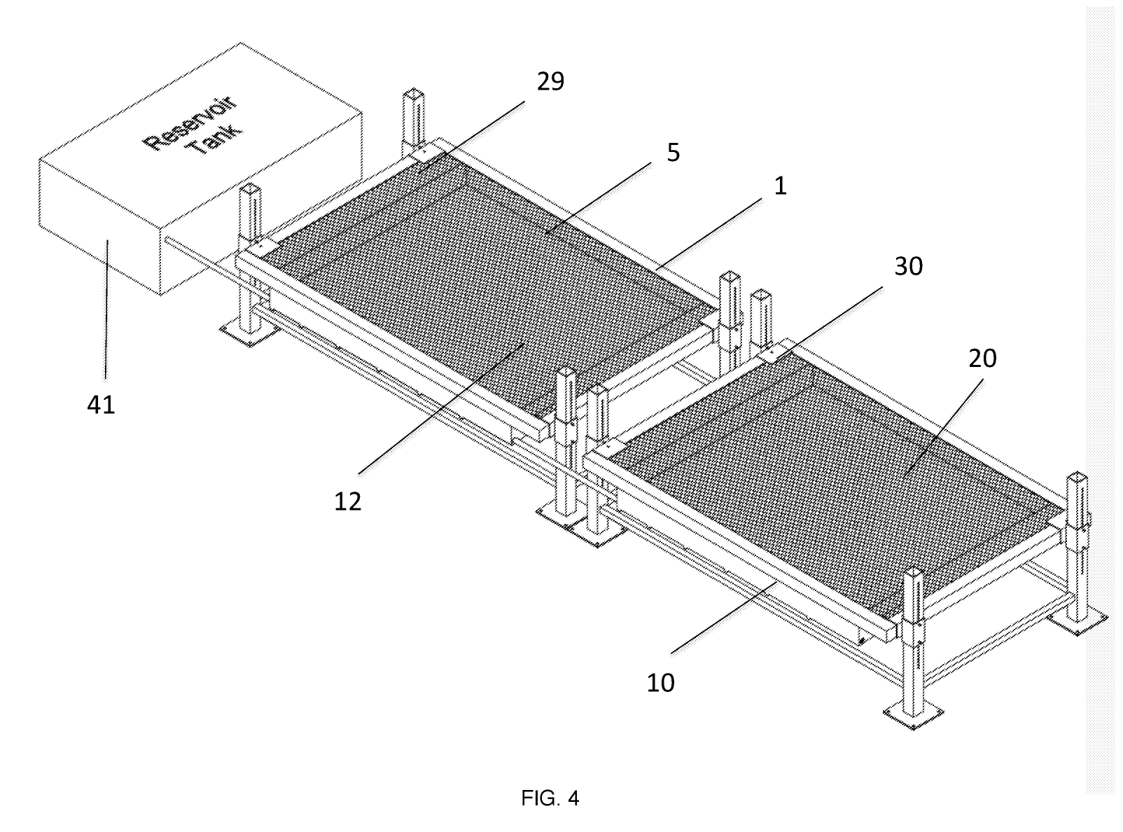

FIG. 4 shows one embodiment of the present invention, where the system is interconnected using interlocking mechanisms. This connection involves the abutment of one tray 5 to another and then using clips 30, or another interlocking mechanism to affix the trays 5 together forming a larger effective water recapture tray 5 surface area, for plants for example. The clips 30 are curved pressure or locking clips 30. When the trays are brought close to one another, a clip 30 could be applied by sliding the open portion of the curve over the a side wall 10 of each tray 5. Pressure clips 30 would hold the trays 5 together by the force transferred from the tension of the curve in the clip 30. Another style of clip 30 may include a locking mechanism that has two parts whereby the clip 30 is one part and another part attached to the sidewall 10 of each tray 5 is adapted to accept an end of the clip 30 thereby holding the sidewalls 10 together. Snaps would hold the trays 5 together when a snap is incorporated into the sidewall 10 of the tray 5 and a corresponding portion of the snap is installed on another sidewall 10 of a tray 5. Channels may be used to allow the trays 5 to slide together. A sidewall 10 may have a section where a channel has been removed from the sidewall 10 and a corresponding sidewall 10 has a section meant to engage the channel. Another example of a channel is when the sidewalls 10 have a small L-shaped protrusion extending outward from the sidewalls 10. Sidewalls 10 with oppositely inverted L-shaped protrusions would interlock thereby holding the trays 5 together.

In another embodiment, the tray has one or more protruding surfaces 29 from the one or more sidewalls of the tray. The protruding surfaces 29 allow for the attachment of the tray to a surface. For example, the protruding surfaces may comprise one or more attachment means such as a clip or fastener. During installation of the tray to the underside of a surface, the clip or fasteners extend from the protruding surfaces 29 to the underside of the surface for attachment. In yet another embodiment, the protruding surfaces 29 act as a lip where the tray is installed by applying pressure to the lip between two objects such as two cinder blocks. In this embodiment, the tray is held in place by the contact between the lip and the cinder blocks through a friction attachment.

In an embodiment, the trays 5 and components are created using synthetic materials. Generally, plastic-like material is used to for all aspects of the system. The filter may be composed of a similar plastic like material or active carbon to provide extra filtering properties to the water passing through.

In a preferred embodiment, the system is in communication to a reservoir tank 41 that acts as a holding tank for excess water in the system. The tank may be in communication to the system by pipes, tubes, a funnel, or another water collection device known in the art.

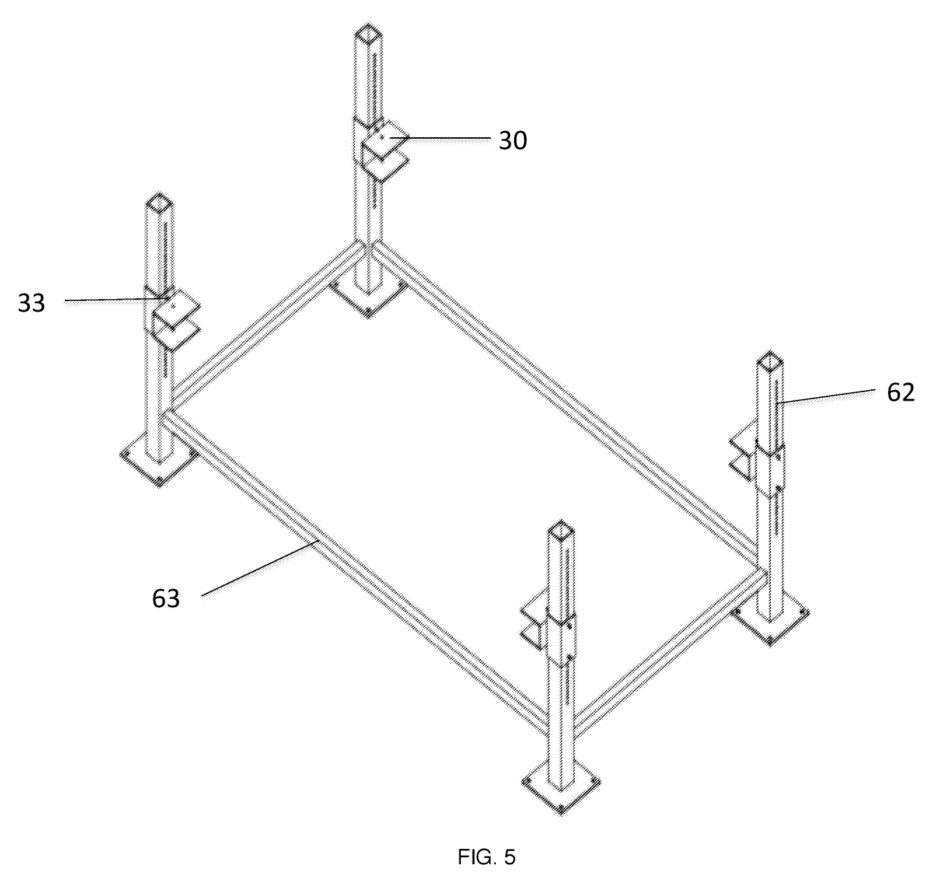

In reference to FIG. 5 In an embodiment, each tray has one or more legs 62 extending outward from an exterior surface of the bottom of the tray. The legs may be static or dynamic that is they may be telescoping or otherwise adjustable. Legs are extendable and rotating in any way. Each leg has a series of through-holes in which the clips 30 are attached. Clips 30 are held in place pins 33 which extend through through-holes of the clips 30. When the through-hole of the clips 30 and the through-hole in the legs are aligned the pins can extend through each in conjunction and hold the clips 30 vertically in place.

In an embodiment, a stand system supports each tray. The stand system has one or more legs with a base and top end. The base contacts the floor and the top end extends from the base, wherein the base promotes stability. Each leg of a single stand system is either static or dynamic allowing for a variable height. The dynamic legs may interlock with one another or telescopically extend the total length of the stand system leg. Each leg has a clip or bracket configured to engage the tray. Each clip of the stand system comprises a first surface, second surface, and third surface. The first and third surfaces extend from the second surface where the contact between the first and second surface, as well as the third and second surface is generally at a right angle. In an embodiment, the second surface is attached to the leg of the stand system. The first and third surfaces have a hole that is coaxially aligned with one another. A pin may be inserted into the holes of the first and third surfaces when the clip is engaged with the tray such that the pin will pass through the hole of the first surface, extend through the tray, and through the hold of the third surface thereby locking the tray into the clip. In an alternative embodiment, each clip is slidably engaged to the leg.

In an embodiment, crossbars 63 support the tray in order to hold one or more legs 62 in place. The crossbars 63 prevent the legs from moving, thus aiding in locking the tray in place.

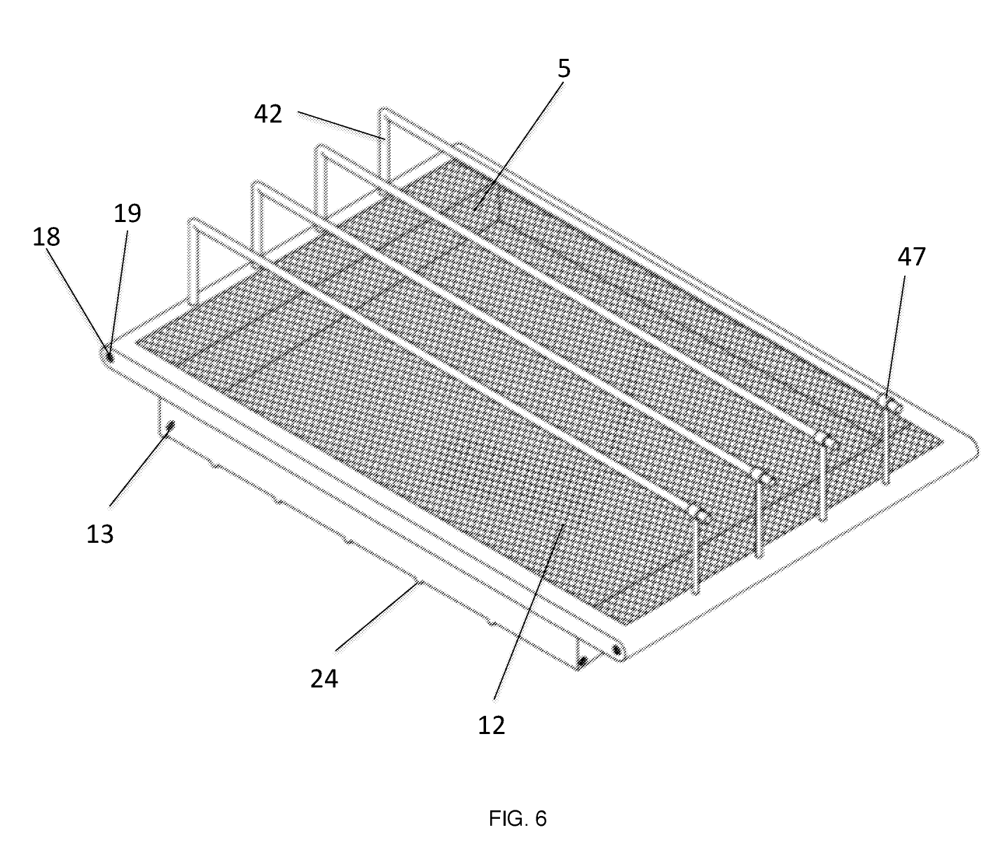

FIG. 6 illustrates a hollow tube where in one embodiment of the present invention, the hole(s) 13 in the bottom surface are the opening of an aperture extending through a hollow tube 18 passing through the bottom surface 12. The hollow tube 18 may have a threaded collar 19 as a hose coupling, that would allow for the connection to a hose system for consolidated water collection from the trays 5. When the hollow tubes 18 do not have a threaded collar 19, a hose is connected using pressure and friction by using a hose corresponding to the size of the hole 13.

In an embodiment, the hollow tube 18 is integrally linked to watering pipes 42, which extend upwards from the hollow tube 18 and extending over the tray. Water may be pumped through the watering tubes 42 by a pump or an integrated pressure system. Holes may be places in the watering tubes 42 in order to water plants placed on the tray.

In another embodiment, the components of the tray system are formed as a single piece where the tubes 42, the tray, and the grate manufactured a single unit.

In an embodiment, the watering tubes 42 are fastened by a cylindrical collar 47 to the opposite end of the tray. The cylindrical collar 47 is fastened to an extension pole underneath the cylindrical collar 47.

In another embodiment, the hollow tube is a junction to link one or more trays together or link one or more tubes and pipes together. The junction has one or more generally concentric collars near a first end and second end. The one or more collars provide a friction fit to the interior surface of an aperture of the tray or an interior surface of a tube. A sleeve extends between the first and second ends. In an embodiment, the junction has a midpoint defined by a plurality of threads for engaging inverse threads of a pipe, tube, or tray. The threads allow for the static placement of the junction during installation.

In another embodiment, each tray has one or more water distributing probes that extend from the interior surface of the bottom of the tray. The water distributing probes have one end in communication with a watering tube and another end extending generally upward from the bottom of the tray. The probes direct the flow of water from the watering tube throughout the plants or objects within the tray. In another embodiment, the water distributing probes are hydraulically activated by the buildup of water pressure from the re-watering system. As the water enters the probes through the tubes, the probe is driven upward to an operational state above the objects in the tray, where it is able to provide coverage of the objects with water from the tubes.

In use, trays may be connected to one another forming a matrix of trays. A filter may be placed in the tray 5 on top of the bottom surface 12. Then the platform 20 is positioned on the top of the tray 5 using a support method previously discussed and incorporated into the sidewalls 10. The platform 20 provides a surface to place an object on such as a plant. When appropriate, the user waters the plant and then, due to gaps between plant pots, excess watering, or other indiscriminate application of water, any water that was not absorbed by the soil in the pot or directed on the plant would then pass through the perforation or grate of the platform 20, through the filter, then collect on the bottom surface 12 of the tray 5. The filter would prevent any debris such as leaves, dirt, stems, etc. from passing through to the bottom surface 12. Through repeated use, the filter may have to be replaced or clean. Replacing the filter would involve removal of the old filter and installation of a new filter in the opposite way it was removed. Other types of filters may be able to be cleaned. To clean the filter, it may be possible to remove the filter then rinse all debris off. An antibacterial spray may be used to further remove any bacterial or mold growth on the filter. Generally understood is the characteristic of water to take a pathway of least resistance, based on gravitational pull. Once on the bottom surface 12, the water would travel either as directed by the bottom surface 12 attributes or by sheer volume on the bottom surface 12, to the hole(s) 13 and subsequently through to the water routing system to a collection vessel where it can be stored and reused.

In an alternative embodiment, the water recapture system has a re-watering system. The re-watering system has one or more sections of pipes connected together to direct the flow of water throughout the re-watering system. One or more of the sections of pipe attach to the tray. One or more ends of the sections of pipe are in communication with a water pump facilitating the flow of water from one or more recapture tanks. The recapture tanks hold a volume of liquid that has traveled through the water recapture system to be stored in the recapture tanks until subsequent re-watering. The flow of water travels from the recapture tanks to the one or more sections of pipe where the water is directed to one or more valves opening to allow the water to exit the one or more sections of pipe and be directed towards an interior section of the tray.

In an embodiment, tubes are used to direct the flow of water from the water pump to the pipes of the re-watering system.

In an embodiment, the one or more valves are in communication with one or more nozzles having various configurations to adjust the flow of the water as it leaves the re-watering system. For example, a shower head or hose sprayer are used to adjust the flow of water from a jet, stream, soak, mist, pulse, spray, etc.

In another embodiment, the re-watering system has an additive device for the introduction of desired additives to the water used for re-watering. The additive device has a container adapted to retain one or more additives until use. The container is connected to a valve for controlling the introduction of the additive to the flow of water. Additives may include fertilizers, stabilizers, water composition modifiers, etc.

In another embodiment, one or more of the tray surfaces comprise a central connection point to engage the tubes of the re-watering system. The tray surfaces also have one or more coplanar tubes, wherein at least one end of each of the coplanar tubes is in communication with the central connection point to direct the flow of water from the tubes of the re-watering system throughout the coplanar tubes of the tray surfaces. In an embodiment, at least one end of the coplanar tubes is in communication with one or more sections of pipe extending from the tray surface to direct the flow of water out of the re-watering system and onto one or more plants within the tray. In another embodiment, the coplanar tubes comprise a plurality of apertures extending through the interior surface of the tray into the coplanar tube allowing the flow of water to exit the plurality of apertures into the tray.

In an embodiment, the valves and spray nozzles are adjustable and omnidirectional via hydraulic activation. For example, the spray nozzles are in communication with the one or more sections of pipes such that the spray nozzles are capable of rotating as built up water pressure transfers force to the connection between the pipes and nozzles. As the force is transferred, the force is sufficient to overcome frictional forces between the nozzles and the connection resulting in a rotation of the spray nozzles. The rotation of the nozzles allows for better watering coverage of the materials within the tray.

In an embodiment, the water recapture and re-watering system is used by a user installing the system by setting one or more trays on a surface or attaching one or more trays to an underside of a surface, such as a table. The trays are clipped together to form a matrix of trays for the system. Placing the filter under the grate of the tray allows water to pass through the grate before passing through the filter. In an embodiment, the tray, tubes, and grate is manufactured as a single unit. In a further embodiment, the grate and platform are removable allowing for the device to be easily cleaned. The water then falls to the bottom surface of the tray where it is directed to one or more holes. The bottom surface of the tray is configured to direct the water using the shape of the bottom surface, any channels, corrugation, etc. The water is directed to the one or more holes and the one or more holes are connected to a system of tubing. The tubes of the tubing system are all in communication with one another and with a water recapture tank. The water is routed to the tank and the tank stores the recaptured water. When a user determines a time where re-watering is necessary, the user engages one or more valves on the water tank. In one embodiment, the water tank is in communication with a pump for actively drive the water from the tank to the re-watering system. In another embodiment, the tank is lifted to allow for a gravity re-distribution system of the water. The gravity system would raise the tank to a level higher than the trays increasing the potential energy and subsequent momentum of the water leaving the tank. When re-watering, the flow of water is opened or initiated from the tank through the tubes of the re-watering system. The water flows through the tubes to the pipe system of each tray for re-watering. Finally, the water leaves the pipe system of each tray to contact and hydrate the objects placed on top of the tray. Once the user has determined enough water has been provided, the re-watering system valves are closed and the system returns to a water recapture position. Essentially, the process forms a flossed loop of watering and recapture of the same.

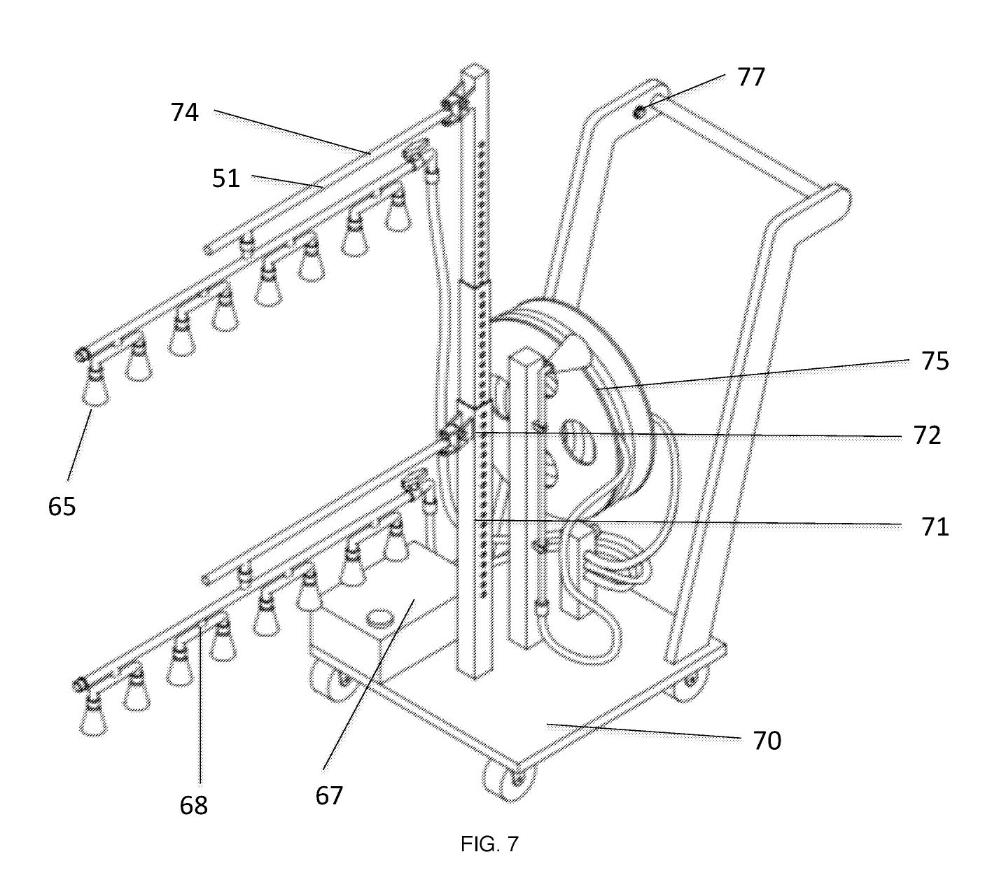

In reference to FIG. 7, the water recapture system has a re-watering module having a moveable base 70 with at least one pole 71 extending upward therefrom. The at least one pole may be static or dynamic whereby the pole height is adjustable through telescopically engaged sections of the pole. A locking mechanism 72 is used to set the height of the adjustable pole in position. The locking mechanism 72 arrests the movement between the telescoping sections. One or more watering devices 74 are attached to the pole and are manipulated by a user for desired water coverage.

In an embodiment, a water source such as the water recapture tank or a hose 75 are connected to the re-watering module. The re-watering module may contain a tank mounted to allow for convenient access to recycled water. The re-watering module may include a hose reel with a separate tank 67 for water storage. The attachment may be at the base, the pole, or the one or more watering devices. For example, an end of a hose from the water source may threadingly engage an adapter located on the base. In this example, the water adapter would have an exposed portion to accept the hose and second portion within the base in communication with one or more channels to direct the flow of water within the re-watering module to the one or more watering devices. In an embodiment, the one or more channels is a second hose.

In an embodiment, the one or more watering devices is at least one sprinkler head 65 attached to an articulating armature 68. One end of the armature is connected to the at least one sprinkler head 65 and the other end of the armature is attached to the pole. The water then comes from the water source, is directed through the re-watering system and exits out of the at least one sprinkler head 65.

In an embodiment, the re-watering module has an ON/OFF controller 77 allowing the user to control water flow, movement, modulation of the sprinklers, and other functional aspects of the device.

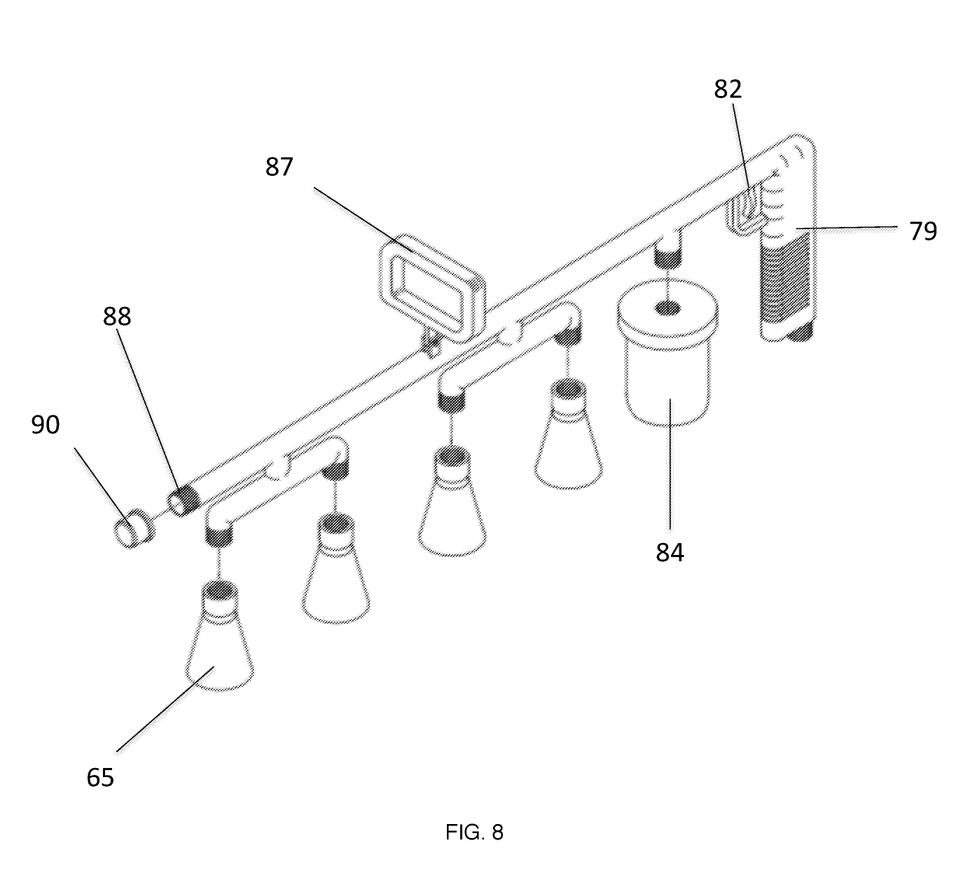

In reference to FIG. 8 a watering device has a length of rigid tubing extending outward from a handle 79. The handle has one or more buttons or triggers 82 mechanically engaged with one or more actuators of one or more valves within the watering device. One end of this type of watering device is in communication with the water from the water source. Another end of this watering device is configured to distribute watering exiting the device. In use, a user operated the trigger to open or close the valves to allow water out of the watering device.

In another embodiment, one or more tubes are attached to an extendable end-piece 88 to a plurality of additional tubes. Functionally, this means the device is scalable to a degree only limited by the strength of materials used. The additional hoses may have the ability to input additional additives such as fertilizer. Once an end point is established in the watering device, an end-cap 90 is placed in order to maintain pressure in the system and expel water through the apertures.

In an embodiment, one or more additive devices 84 may be integrated into the watering device, distributing an additive of choice into the water channel of the device. It is possible for an additive device 84 to be input at each additional extension of the device in separate embodiments.

In another embodiment, each extendable section may have the ability to input an additional additive specific to each section.

In a preferred embodiment, a handle 87 is in communication with the watering device in order to aid in the grip thereof as well as to supply water to said device.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A water recapture system comprising:
a. one or more trays having a bottom surface and one or more sidewalls extending upward from the bottom surface, wherein the bottom surface has at least one aperture extending therethrough;
b. a platform configured to engage a top side of the one or more sidewalls, wherein the platform has a first tab and a second tab, wherein the first tab and the second tab extend outwardly from the platform; and
c. a coupler extending through the at least one aperture of the bottom surface, wherein one end of the coupler is exterior to the tray, and wherein a hose attached to the one end of the coupler,
wherein the bottom surface of the tray is contoured, and wherein the contour of the bottom surface is biased towards the at least one aperture.

2. The system of claim 1, wherein the trays are interlocking, wherein one or more of the sidewalls comprise a plurality of clips, and wherein the clips connect separate trays together.

3. The system of claim 1, further comprising one or more filters, wherein the one or more trays comprise an opening through an upper edge of at least one of the sidewalls, wherein the one or more filters are axially aligned with the bottom surface of the tray.

4. The system of claim 1, wherein the contour of the bottom surface facilitates excess water flow throughout the bottom surface of the tray to the at least one aperture, wherein the contour of the bottom surface is selected from the group consisting of: curved, channeled, corrugated, and tapered.

5. The system of claim 1, further comprising at least one tank having a plurality of openings, wherein each hose of the one or more trays is in communication with at least one opening of the tank, wherein the tank receives excess water.

6. The system of claim 5, further comprising:
a. a power source;
b. at least one pump electrically connected to the power source, wherein the pump pumps water held inside the tank to a re-watering system.

7. The system of claim 5, wherein the re-watering system further comprises at least one hose having a first end attached to the pump and a second end attached to a watering device, wherein the watering device directs the flow of water from the pump.

8. A water recapture system comprising:
a. one or more trays having a bottom surface and one or more sidewalls extending upward from the bottom surface, wherein the bottom surface has at least one aperture extending therethrough;
b. a platform configured to engage a top side of the one or more sidewalls;
c. a coupler extending through the at least one aperture of the bottom surface, wherein one end of the coupler is exterior to the tray, and wherein a hose attached to the one end of the coupler;
d. a re-watering system having at least one tank in communication with the one or more trays;
e. one or more re-watering devices in communication with the tank;
wherein the bottom surface of the tray is contoured, wherein the contour of the bottom surface is biased towards the at least one aperture, wherein the tank receives excess water, wherein the one or more re-watering devices directs the flow of the excess water.

9. The system of claim 8, wherein at least one of the one or more re-watering devices comprises:
a. a base;
b. a pole extending upwardly from the base; and
c. a watering module in communication with the pole.

10. The system of claim 9, wherein the base further comprises at least one attachment mechanism to receive a hose extending from the tank to the at least one re-watering device, wherein the attachment mechanism is in communication with the watering module.

11. The system of claim 9, further comprising an articulating armature attached to the pole, wherein the armature extends and retracts generally perpendicular from the pole, and wherein the watering module is attached to an opposite end of the armature from the pole.

12. The system of claim 9, wherein the pole comprises a plurality of pole sections, wherein each pole section is telescopically engaged with an adjacent pole section.

13. The system of claim 9, wherein the water module comprises:
a. a handle having a trigger mechanism, wherein the trigger mechanism is mechanically connected to at least one actuator, wherein the at least one actuator controls one or more valves;
b. a tube extending from the handle; and
c. at least one sprinkler head attached to the tube,
wherein the sprinkler head directs the flow of water from the re-watering device.
